(19) United States
(12) Patent Application Publication
(10) Pub. No.: US 2018/0012368 A1
(43) Pub. Date: Jan. 11, 2018

(54) MOVING OBJECT DETECTION DEVICE, IMAGE PROCESSING DEVICE, MOVING OBJECT DETECTION METHOD, AND INTEGRATED CIRCUIT

(71) Applicant: Panasonic Intellectual Property Management Co., Ltd., Osaka (JP)

(72) Inventors: Yuya TANAKA, Kyoto (JP); Yoshihito OHTA, Osaka (JP); Kenji TAKITA, Osaka (JP)

(21) Appl. No.: 15/712,823

(22) Filed: Sep. 22, 2017

Related U.S. Application Data
(63) Continuation of application No. PCT/JP2016/000124, filed on Jan. 12, 2016.

(30) Foreign Application Priority Data
Mar. 26, 2015 (JP) 2015-065291

(51) Int. Cl. G06K 9/48

(52) U.S. Cl. CPC G06T 7/223; G06K 9/481; G06T 7/254; G06T 7/162; G06T 7/11; G06T 2207/20224; G06T 2207/30261

(57) ABSTRACT

A moving object detection device includes: an image capturing unit with which a vehicle is equipped, and which is configured to obtain a captured image by capturing a view in a travel direction of the vehicle; a calculation unit configured to calculate, for each of first regions which are unit regions of the captured image, a first motion vector indicating movement of an image in the first region; an estimation unit configured to estimate, for each of one or more second regions which are unit regions each including first regions, a second motion vector using first motion vectors, the second motion vector indicating movement of a stationary object which has occurred in the captured image due to the vehicle traveling; and a detection unit configured to detect a moving object present in the travel direction, based on a difference between a first motion vector and a second motion vector.

### CROSS REFERENCE TO RELATED APPLICATIONS

This is a continuation application of PCT International Application No. PCT/JP2016/000124 filed on Jan. 12, 2016, designating the United States of America, which is based on and claims priority of Japanese Patent Application No. 2015-065291 filed on Mar. 26, 2015. The entire disclosures of the above-identified applications, including the specifications, drawings and claims are incorporated herein by reference in their entirety.

### FIELD

The present disclosure relates to a moving object detection device, an image processing device, and a moving object detection method.

### BACKGROUND

A traditional technique of detecting, for instance, a pedestrian present in the vicinity of a vehicle, and controlling the vehicle according to the result of the detection has been known. For example, Patent Literature (PTL) 1 discloses a technique of identifying an object such as a pedestrian by performing processing such as pattern matching on an image obtained by an on-board image capturing device.

### CITATION LIST

### Patent Literature

[PTL 1] Japanese Unexamined Patent Application Publication No. 2007-58751

### SUMMARY

### Technical Problem

The present disclosure provides a moving object detection device which can detect a moving object from an image captured by an on-board camera of a vehicle in motion, an image processing device, and a moving object detection method.

### Solution to Problem

A moving object detection device according to the present disclosure includes: an image capturing unit with which a vehicle is equipped, and which is configured to obtain a captured image by capturing a view in a travel direction of the vehicle; a calculation unit configured to calculate, for each of first regions which are unit regions of the captured image, a first motion vector indicating movement of an image in the first region; an estimation unit configured to estimate, for each of one or more second regions which are unit regions each including the first regions, a second motion vector using first motion vectors of the first regions included in the second region, the second motion vector indicating movement of a stationary object which has occurred in the captured image due to the vehicle traveling; and a detection unit configured to detect a moving object present in the travel direction, based on a difference between one of the first motion vectors and one of the one or more second motion vectors.

### Advantageous Effects

According to the present disclosure, a moving object can be detected from an image captured by an on-board camera of a vehicle in motion.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram illustrating a functional configuration of a moving object detection device according to an embodiment.

FIG. 2 is a diagram illustrating a vehicle equipped with the moving object detection device according to the embodiment.

FIG. 3 is a diagram illustrating a captured image according to the embodiment.

FIG. 4 is an explanatory diagram illustrating processing of calculating a motion vector for each block of a captured image according to the embodiment.

FIG. 5 is an explanatory diagram illustrating processing of estimating motion vectors indicating movement of stationary objects according to the embodiment.

FIG. 6 is a diagram illustrating an estimated motion vector of a stationary object according to the embodiment.

FIG. 7 is an explanatory diagram illustrating processing of detecting a moving object according to the embodiment.

FIG. 8 is a flow chart illustrating operation (moving object detection method) of the moving object detection device according to the embodiment.

### DESCRIPTION OF EMBODIMENTS

The following describes in detail embodiments with reference to the drawings as appropriate. However, an unnecessarily detailed description may be omitted. For example, a detailed description of a matter already known well and a redundant description of substantially the same configuration may be omitted. This is intended to avoid making the following description unnecessarily redundant and to facilitate understanding of a person skilled in the art.

Note that the inventors provide the accompanying drawings and the following description in order that a person skilled in the art sufficiently understands the present disclosure, and thus do not intend to limit the subject matter of the claims by the drawings and the description. The embodiments described below each show a particular example of the present disclosure. The numerical values, shapes, materials, elements, the arrangement and connection of the elements, steps, the processing order of the steps, and the like described in the following embodiments are examples, and thus are not intended to limit the technology in the present disclosure. Therefore, among the elements in the following embodiments, elements not recited in any of the independent claims defining the most generic concept of the present disclosure are described as arbitrary elements.

The drawings are schematic diagrams, and thus do not necessarily provide strictly accurate illustration. Furthermore, the same numeral is given to the same element throughout the drawings.

### Embodiment

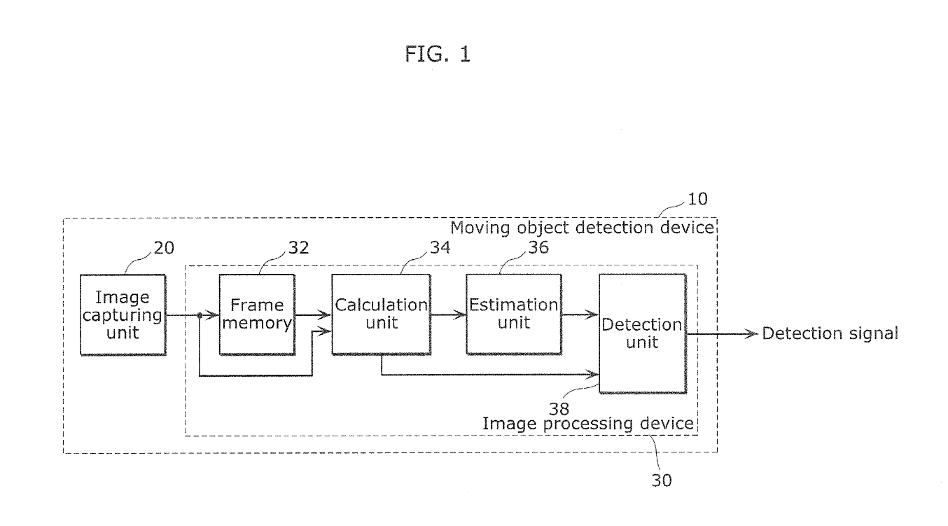

The following describes, for instance, a moving object detection device according to the embodiment, with reference to FIGS. 1 to 8.

### [1. Configuration]

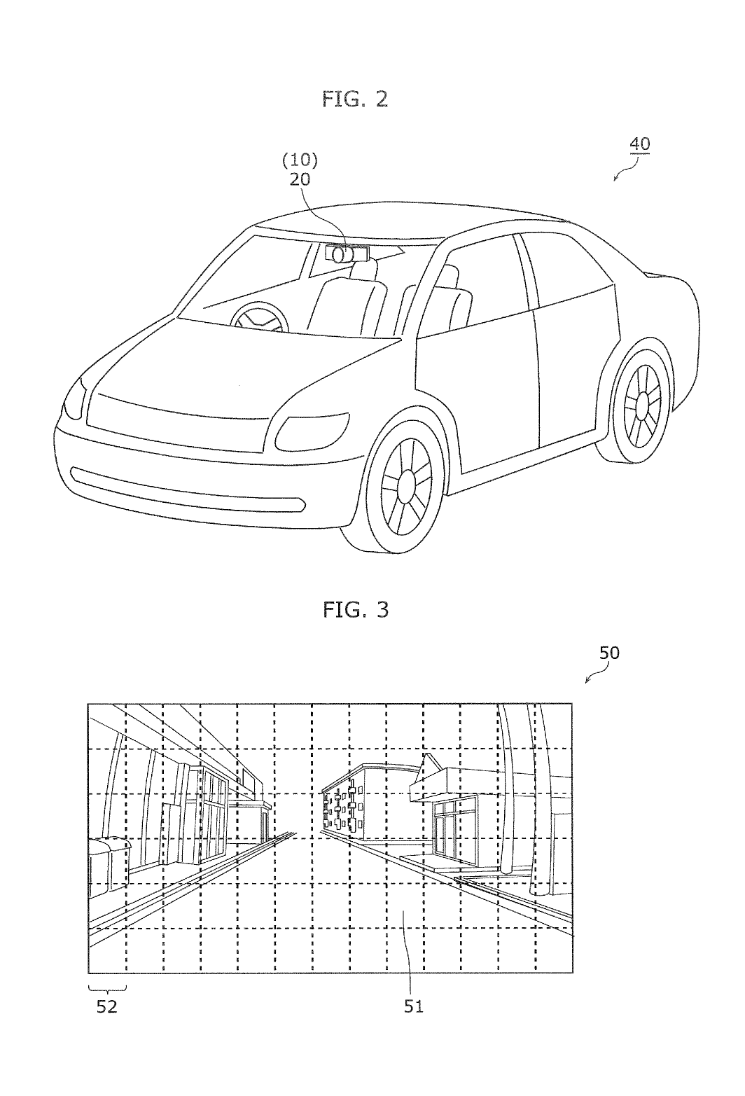

FIG. 1 is a block diagram illustrating a functional configuration of a moving object detection device 10 according to the present embodiment. FIG. 2 is a diagram illustrating a vehicle 40 equipped with the moving object detection device 10 according to the present embodiment. The moving object detection device 10 includes an image capturing unit 20 and an image processing device 30 as illustrated in FIG. 1.

The image capturing unit 20 is provided in the vehicle 40 as illustrated in FIG. 2. The image capturing unit 20 captures a view in the travel direction of the vehicle 40, to obtain a captured image. Specifically, the image capturing unit 20 captures a view in the travel direction of the vehicle 40 while the vehicle 40 is moving (in motion) in the travel direction, to obtain a captured image. More specifically, the image capturing unit 20 captures an image of a space outside of the vehicle 40 in the travel direction, that is, a space ahead of the vehicle 40, for example. Captured images constitute a video which includes a plurality of frames.

The image capturing unit 20 is an on-board camera, and is attached to the ceiling of the vehicle 40, or the upper surface of a dashboard, for example. Accordingly, the image capturing unit 20 captures a view ahead of the vehicle 40. Note that the image capturing unit 20 may be attached to the outside of the vehicle 40, rather than the inside thereof.

The image processing device 30 is for detecting a moving object present in the travel direction of the vehicle 40, using captured images obtained by the image capturing unit 20. The image processing device 30 is achieved by, for example, a microcomputer which includes a program, a memory, and a processor. The vehicle 40 may be equipped with the image processing device 30 that is achieved integrally with the image capturing unit 20 or separately from the image capturing unit 20, for example.

The image processing device 30 includes a frame memory 32, a calculation unit 34, an estimation unit 36, and a detection unit 38 as illustrated in FIG. 1.

The frame memory 32 is a memory for storing captured images obtained by the image capturing unit 20. The frame memory 32 stores a captured image for one frame, for example. The frame memory 32 is a volatile memory, for example.

The calculation unit 34 calculates, for each of first regions which are unit regions of a captured image, a first motion vector indicating movement of an image in the first region. The first motion vector indicates a direction in which and how much the image in the first region has moved. The first region is a block made up of one or more pixels. A block is, for example, a rectangular region, and is a group of 8×8 pixels, which is an example.

Specifically, the calculation unit 34 divides a captured image 50 into a plurality of blocks 51, as shown in FIG. 3. Note that FIG. 3 is a diagram illustrating a captured image 50 according to the present embodiment. In the present embodiment, the calculation unit 34 divides the captured image 50 into blocks 51 in M rows and N columns. In other words, the blocks 51 are unit regions obtained by dividing the captured image 50 into rows and columns. Note that M and N each represent a natural number of 2 or more.

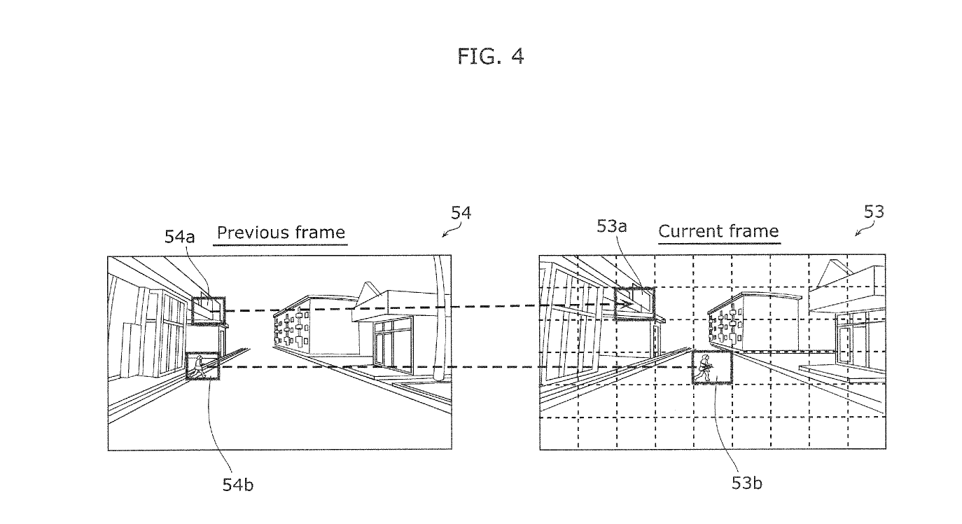

FIG. 4 is an explanatory diagram illustrating processing of calculating a motion vector for each block of a captured image according to the present embodiment. The calculation unit 34 calculates a first motion vector of each block 51 in a frame, by block matching between frames which are captured images. For example, the calculation unit 34 searches for the most matching blocks by performing, for each block 51 in a current frame 53 and a previous frame 54, evaluation in which a distance function is used, such as calculating an absolute error or a square error of values of pixels included in blocks 51 in the same relative position of the current frame 53 and the previous frame 54, as illustrated in FIG. 4.

For example, the result of block matching shows that a block 53a and a block 53b in the current frame 53 correspond to a block 54a and a block 54b in the previous frame 54, respectively. A vector indicating an amount and a direction of movement from the block 54a to the block 53a corresponds to a first motion vector of the block 53a. The same applies to the first motion vector of the block 53b.

Note that the current frame 53 is input from the image capturing unit 20 to the calculation unit 34. The previous frame 54 is currently held in the frame memory 32 and is, for example, a frame immediately previous to the current frame 53. The current frame 53 and the previous frame 54 are, for example, two frames successive in the capturing order (input order) among a plurality of frames which are captured images, but are not limited such successive frames. For example, it is sufficient if the previous frame 54 is a frame captured previously to the current frame 53, and thus the previous frame 54 may be a frame captured previously to the current frame 53 by two or more frames. Note that the calculation unit 34 may use a frame captured after the current frame 53 is captured, instead of the previous frame 54.

The estimation unit 36 estimates, for each of second regions which is larger than the first region, a second motion vector indicating movement of a stationary object that has occurred in a captured image due to the vehicle 40 traveling, using first motion vectors of first regions included in the second region. The second region is a unit region that includes a plurality of first regions. In the present embodiment, the second region is a column 52 which includes a column of blocks 51, as illustrated in FIG. 3.

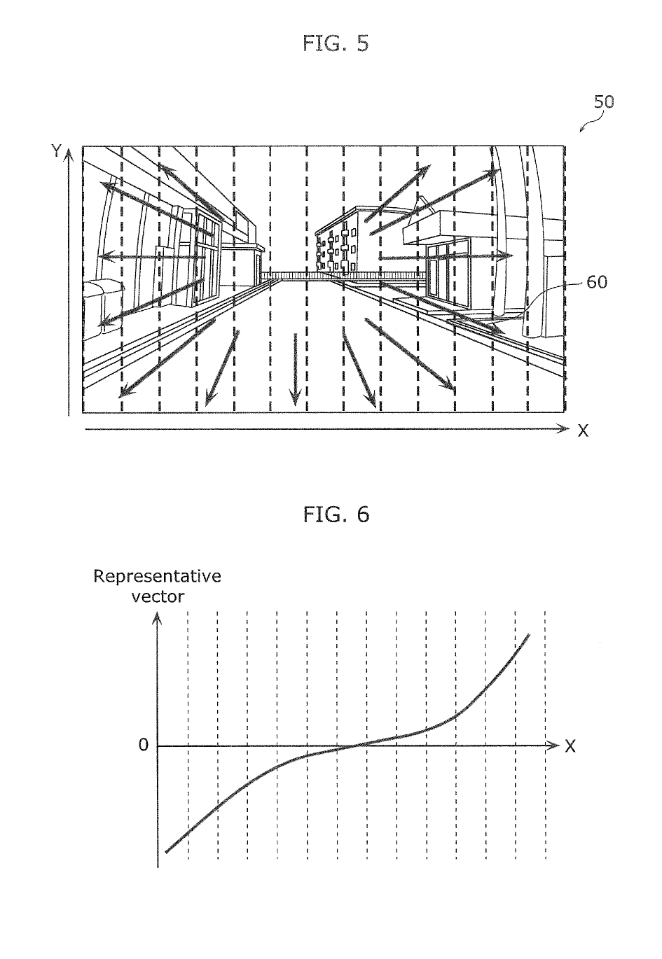

FIG. 5 is an explanatory diagram illustrating processing of estimating motion vectors indicating movement of stationary objects according to the present embodiment. Normally, stationary objects dominantly occupy the captured image 50. Stated differently, the proportion (area or the number of blocks) of the captured image 50 occupied by stationary objects is higher than the proportion (area or the number of blocks) of the captured image 50 occupied by a moving object.

A stationary object is an object at rest in a real space. Stationary objects correspond to, for example, backgrounds such as ground (roads), sky, and structures including traffic lights, vehicle guard fences (crash barriers), and buildings. Note that stationary objects may include objects which slightly move due to, for instance, winds, such as a roadside tree and a cable. Specifically, a stationary object may be an object whose amount of movement is regarded or can be regarded as 0.

A moving object is an object moving in a real space. Examples of moving objects include animals such as persons and pets, and vehicles such as motorcycles and cars. Note that moving objects may also include unfixed objects such as garbage cans and standing signboards.

The arrows illustrated in FIG. 5 represent estimated second motion vectors 60 of stationary objects. As illustrated in FIG. 5, when the vehicle 40 travels forward, the second motion vectors 60 of the stationary objects radially extend. Specifically, the image capturing unit 20 obtains a captured image 50 (video) showing that the stationary objects are moving radially from the center of a view in the travel direction, by capturing a view ahead when the vehicle 40 travels forward.

In the present embodiment, the estimation unit 36 estimates, as a second motion vector, a representative vector representing a plurality of first motion vectors of blocks 51 included in a column 52. Specifically, the estimation unit 36 calculates, as a representative vector, the representative value of the first motion vectors of a column of the blocks 51 in the column 52. For example, the estimation unit 36 calculates the average value or the mean value of the first motion vectors of a column of the blocks 51, as a representative vector.

FIG. 6 is a diagram illustrating an estimated motion vector of a stationary object according to the present embodiment. Specifically, FIG. 6 is a diagram illustrating a motion vector of a stationary object in the X axis direction (row direction), assuming that the rightward direction is the positive direction.

The estimation unit 36 calculates, for each column 52, a second motion vector, based on robust estimation, for example. Random Sample Consensus (RANSAC) can be used as robust estimation, for example. Accordingly, even if the captured image 50 includes a moving object, a second motion vector of a stationary object can be estimated while excluding the moving object.

Note that a motion vector of a stationary object in the X axis direction (row direction) is illustrated in the example in FIG. 6, yet a motion vector in the Y axis direction (column direction) can also be estimated similarly. In this case, the estimation unit 36 may use, for example, a region which includes a row of blocks 51, as a second region.

The detection unit 38 detects a moving object present in the travel direction of the vehicle 40, based on a difference between one of the first motion vectors and one of the second motion vectors. Specifically, the detection unit 38 calculates, for each of blocks 51, a third motion vector by subtracting, from the first motion vector of the block 51, the second motion vector of the second region that includes the block 51, and based on the calculated third motion vector, determines whether a moving object is present in the block 51 to detect a moving object.

For example, when the magnitude of the third motion vector of a first region is greater than a predetermined threshold, and the direction of the third motion vector is toward an approximate center of a captured image, the detection unit 38 determines that a moving object is present in the first region. Accordingly, by determining, for each block 51, whether a moving object is present in the block 51, the detection unit 38 can detect a block 51 in which a moving object is present in a captured image. Stated differently, the detection unit 38 detects, in a real space, a moving object present in a region corresponding to a block 51 in which a moving object is detected.

The predetermined threshold may be, for example, a fixed value for all the regions of a captured image, or may vary depending on the position of a block 51. For example, a low threshold may be used for a block 51 at or near the center of a captured image, or a high threshold may be used for a block 51 distant from the center of a captured image.

The center of a captured image is the middle of a captured image, for example. Alternatively, the center of a captured image may be a vertical line passing through the middle of the captured image. In addition, the center of a captured image may be a movement vanishing point. A movement vanishing point is a point at which lines extending from the starting points of motion vectors of stationary objects that occur in a captured image converge when an observer (here, the vehicle 40) makes a translation motion, and at which movement due to the vehicle 40 traveling does not occur. For example, when the vehicle 40 is traveling straight forward, the movement vanishing point is substantially in the middle of a captured image. For example, when a camera (the image capturing unit 20) is disposed such that the optic axis is parallel to the ground contact surface of the vehicle 40 and the travel direction of the vehicle 40, the movement vanishing point when the vehicle 40 is traveling straight ahead substantially matches the middle of a captured image.

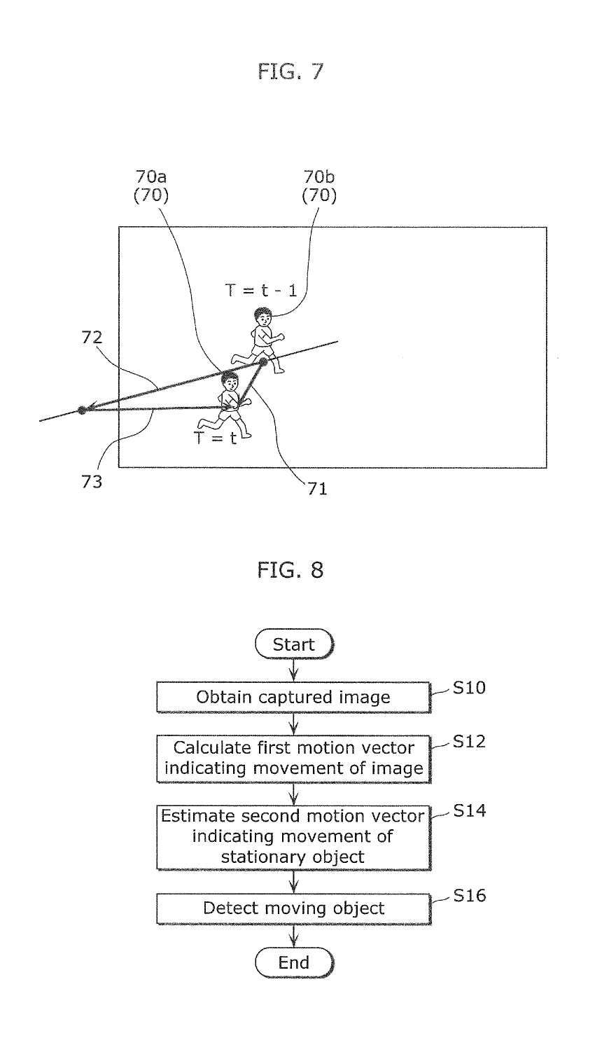

FIG. 7 is an explanatory diagram illustrating processing of detecting a moving object 70 according to the present embodiment. In FIG. 7, a moving object 70a shows the position of a moving object 70 at time t (current frame 53). A moving object 70b shows the position of the moving object 70 at time t-1 (previous frame 54).

The detection unit 38 calculates a third motion vector 73 by subtracting a second motion vector 72 from a first motion vector 71, as illustrated in FIG. 7. Specifically, the detection unit 38 calculates the third motion vector 73, using the first motion vector 71 of a block from which the third motion vector 73 is to be calculated and the second motion vector 72 of a column that includes the block.

The magnitude of the third motion vector 73 indicates the amount of movement of the moving object 70. The direction of the third motion vector 73 indicates the direction in which the moving object 70 has moved in the real space. Thus, if the magnitude of the third motion vector 73 is greater than a threshold and the direction of the third motion vector 73 is toward an approximate center, it is meant that the moving object 70 is to enter the route in the travel direction of the vehicle 40 (in other words, a region where the vehicle 40 is to advance), or in other words, there will be danger. Therefore, the danger for the vehicle 40 can be perceived by the detection unit 38 detecting the moving object 70. Accordingly, control for avoiding danger can be performed, for example.

In the present embodiment, the detection unit 38 outputs a detection signal if the detection unit 38 detects a moving object. Specifically, a detection signal is output to, for instance, a brake control unit or a notification unit of the vehicle 40. For example, the brake control unit decelerates the vehicle 40, based on the detection signal. For example, the notification unit produces, for instance, a warning beep or shows an alarm display, based on the detection signal, thus notifying a driver or a moving object (for example, a child running out) of the danger. This provides driving support to avoid danger, for instance.

### [2. Operation (Moving Object Detection Method)]

FIG. 8 is a flow chart illustrating operation (moving object detection method) of the moving object detection device 10 according to the present embodiment.

First, the image capturing unit 20 obtains a captured image (video) by capturing a view in the travel direction of the vehicle 40 (S10: image capturing step). A captured image is stored in the frame memory 32 and input to the calculation unit 34, frame-by-frame, for example.

Next, the calculation unit 34 calculates, for each block 51 of a captured image, a first motion vector indicating movement of an image in the block 51 (S12: calculation step). Specifically, the calculation unit 34 performs block matching for each block 51, using the current frame 53 input from the image capturing unit 20 and the previous frame 54 read from the frame memory 32, thus calculating the first motion vector of the block 51.

Next, the estimation unit 36 estimates, for each column 52, a second motion vector indicating movement of a stationary object, using first motion vectors (S14: estimation step). Specifically, the estimation unit 36 calculates, for each column 52, a representative vector representing first motion vectors of a column of blocks 51 included in the column 52. For example, the estimation unit 36 calculates the average value of the first motion vectors of a column of blocks 51, and estimates the calculated average value as the second motion vector of the column 52. In this case, the estimation unit 36 can estimate the second motion vector more accurately by using robust estimation such as RANSAC.

Next, the detection unit 38 detects a moving object, based on a difference between the first motion vector calculated for a block 51 and the second motion vector estimated for a column 52 (S16: detection step). Specifically, the detection unit 38 calculates, for each block 51, a third motion vector by subtracting the second motion vector of a column 52 which includes the block 51 from the first motion vector of the block 51. The detection unit 38 determines, for each block 51, whether a moving object is present in the block 51, based on the magnitude and the direction of the third motion vector calculated for the block 51. For example, when the magnitude of the third motion vector of a block 51 is greater than a predetermined threshold, and the direction of the third motion vector is toward an approximate center of a captured image, the detection unit 38 determines that a moving object is present in the block 51.

Accordingly, the moving object 70 which is moving toward the route in the travel direction of the vehicle 40 can be detected, as illustrated in FIG. 7, for example. Therefore, for example, a child running out can be detected and danger assessment can be conducted.

### [3. Advantageous Effects and Others]

As described above, a moving object detection device 10 according to the present embodiment includes: an image capturing unit 20 with which a vehicle 40 is equipped, and which is configured to obtain a captured image by capturing a view in a travel direction of the vehicle 40; a calculation unit 34 configured to calculate, for each of blocks which are unit regions of the captured image, a first motion vector indicating movement of an image in the block; an estimation unit 36 configured to estimate, for each of one or more columns which are unit regions each including blocks among the blocks, a second motion vector using first motion vectors of the blocks included in the column, the second motion vector indicating movement of a stationary object which has occurred in the captured image due to the vehicle 40 traveling; and a detection unit 38 configured to detect a moving object present in the travel direction, based on a difference between one of the first motion vectors and one of the one or more second motion vectors.

According to a traditional technology, a moving object may not be detected from a captured image, depending on an environment where a vehicle is traveling. For example, when a moving object is moving parallel to the vehicle, or when a moving object is moving in a direction perpendicular to the vehicle, a motion vector of the moving object relative to the vehicle is 0, and thus the moving object cannot be recognized as an object that is in motion.

In view of this, according to the moving object detection device 10 according to the present embodiment, a difference between a first motion vector calculated for each block of a captured image and a second motion vector of a stationary object which occurs due to the vehicle 40 traveling is used, and thus a moving object can be detected from a captured image obtained by the vehicle 40 in motion. Specifically, a motion vector of the moving object can be calculated by eliminating a motion vector component of a stationary object estimated from the motion vector of the captured image. Accordingly, a moving object present in the travel direction of the vehicle 40 can be detected accurately.

For example, in the present embodiment, for each of the one or more columns, the estimation unit 36 is configured to estimate, as the second motion vector, a representative vector representing the first motion vectors of the blocks included in the column.

Accordingly, a plurality of first motion vectors are used, and thus a second motion vector can be estimated more accurately. The accuracy of detecting a moving object can be, therefore, further increased.

For example, in the present embodiment, the blocks which are the unit regions are obtained by dividing the captured image into rows and columns, and each of the one or more columns includes a row or a column of first blocks among the blocks.

Accordingly, for example, when first motion vectors of a column of blocks are used, a second motion vector for the column can be estimated more accurately. Alternatively, when first motion vectors of a row of blocks are used, a second motion vector for the row can be estimated more accurately. Thus, the accuracy of detecting a moving object can be further increased. A moving object which is moving not only in the left-right direction (horizontal direction), but also in the depth direction can be detected by calculating a second motion vector for each of the X-axis direction and the Y-axis direction.

For example, in the present embodiment, the detection unit 38 is configured to calculate, for each of the blocks, a third motion vector by subtracting, from the first motion vector of the block, the second motion vector of the column which includes the block, and detect the moving object by determining whether the moving object is present in the block, based on the third motion vector.

Accordingly, the existence of a moving object is determined for each block, and thus the accuracy of detecting a moving object can be further increased.

For example, in the present embodiment, when a magnitude of the third motion vector of a block among the blocks is greater than a predetermined threshold and a direction of the third motion vector is toward an approximate center of the captured image, the detection unit 38 is configured to determine that the moving object is present in the block.

Accordingly, the direction and the amount of movement of a moving object can be estimated, and thus whether the moving object is approaching the vehicle 40 and how close the moving object is can be determined. In other words, according to the moving object detecting device 10 according to the present embodiment, a moving object that is highly dangerous to the vehicle 40 can be detected.

A moving object detection method according to the present embodiment includes: obtaining a captured image by capturing a view in a travel direction of a vehicle 40; calculating, for each of blocks which are unit regions of the captured image, a first motion vector indicating movement of an image in the block; estimating, for each of one or more columns which are unit regions each including blocks among the blocks, a second motion vector using first motion vectors of the blocks included in the column, the second motion vector indicating movement of a stationary object which has occurred in the captured image due to the vehicle 40 traveling; and detecting a moving object present in the travel direction, based on a difference between one of the first motion vectors and one of the one or more second motion vectors.

Accordingly, a moving object can be detected from a captured image obtained by the on-board camera of the vehicle 40 in motion.

An image processing device or an integrated circuit according to the present embodiment includes: a calculation unit 34 configured to calculate, for each of blocks which are unit regions of a captured image obtained by an image capturing device capturing a view in a travel direction of a vehicle 40 which is equipped with the image capturing device, a first motion vector indicating movement of an image in the block; an estimation unit 36 configured to estimate, for each of one or more columns which are unit regions each including blocks among the blocks, a second motion vector using first motion vectors of the blocks included in the column, the second motion vector indicating movement of a stationary object which has occurred in the captured image due to the vehicle 40 traveling; and a detection unit 38 configured to detect a moving object present in the travel direction, based on a difference between one of the first motion vectors and one of the one or more second motion vectors.

Accordingly, a moving object can be detected from a captured image obtained by the on-board camera of the vehicle 40 in motion.

Note that the technology in the present disclosure can be achieved as not only the moving object detection device, the image processing device, and the moving object detection method, but also as a program which includes the moving object detection method and/or the image processing method as steps, and a computer-readable recording medium such as a digital versatile disc (DVD) in which the program is stored.

Thus, the general or particular aspect described above may be achieved as a system, a device, an integrated circuit, a computer program, or a computer-readable recording medium, or may be achieved as an arbitrary combination of systems, devices, integrated circuits, computer programs, or computer-readable recording media.

### Other Embodiments

This completes description of the embodiment, as an example of the technology disclosed in the present application. However, the technology according to the present disclosure is not limited to this, and is also applicable to embodiments as a result of appropriate modification, replacement, addition, and omission, for instance.

The following describes other embodiments.

For example, the above embodiment has described an example in which the calculation unit 34 calculates a motion vector using two captured images, yet the present disclosure is not limited to this. For example, the calculation unit 34 may calculate a motion vector using three or more captured images. Accordingly, a more highly accurate motion vector can be calculated, and thus the accuracy of detecting a moving object can be increased. Note that in this case, the image processing device 30 may include a plurality of frame memories 32, for example. Alternatively, the frame memory 32 may store two or more frames of captured images.

For example, the above embodiment has described an example in which the second region includes a row of or a column of blocks. For example, a column 52 may include a plurality of columns of blocks. Alternatively, the second region may include a plurality of rows and a plurality of columns of blocks, such as two rows and two columns of blocks.

For example, although the above embodiment has described the case where the travel direction of the vehicle 40 is frontward of the vehicle 40, but may be backward of the vehicle 40. Specifically, the vehicle 40 may travel backward (be reversed), and in this case, the image capturing unit 20 may capture a view behind the vehicle 40. For example, the image capturing unit 20 may change the direction in which images are captured, or another capturing unit which captures a backward view may be attached to the vehicle 40.

For example, the above embodiment has described an example in which the vehicle 40 is equipped with the image processing device 30, yet the present disclosure is not limited to this. The image processing device 30 may be, for instance, a server apparatus provided separately from the vehicle 40, and obtain a captured image via a network from the image capturing unit 20 (on-board camera) with which the vehicle 40 is equipped. Alternatively, the image processing device 30 may obtain a captured image obtained by the on-board camera and stored in, for instance, a recording medium, by reading the captured image from the recording medium, for instance.

For example, the estimation unit 36 may estimate second motion vectors using a movement vanishing point. The accuracy of robust estimation such as RANSAC can be increased by using a movement vanishing point. Thus, the accuracy of detecting a moving object can be improved.

The above has described embodiments as examples of the technology according to the present disclosure. For the description, the accompanying drawings and the detailed description are provided.

Thus, the elements illustrated in the accompanying drawings and described in the detailed description may include not only elements necessary for addressing problems, but also elements not necessarily required for addressing the problems, in order to illustrate the above technology. Accordingly, a fact that such unnecessarily required elements are illustrated in the accompanying drawings and described in the detailed description should not immediately lead to a determination that such unnecessarily required elements are required.

In addition, the embodiments described above are intended to illustrate the technology according to the present disclosure, and thus various modifications, replacement, addition, and omission, for instance, can be performed within the scope of claims and equivalent thereof.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The moving object detection device, the image processing device, and the moving object detection method according to the present disclosure are applicable to an on-board camera, for example.

1. A moving object detection device comprising:
an image capturing unit with which a vehicle is equipped, and which is configured to obtain a captured image by capturing a view in a travel direction of the vehicle;
a calculation unit configured to calculate, for each of first regions which are unit regions of the captured image, a first motion vector indicating movement of an image in the first region;
an estimation unit configured to estimate, for each of one or more second regions which are unit regions each including the first regions, a second motion vector using first motion vectors of the first regions included in the second region, the second motion vector indicating movement of a stationary object which has occurred in the captured image due to the vehicle traveling; and
a detection unit configured to detect a moving object present in the travel direction, based on a difference between one of the first motion vectors and one of the one or more second motion vectors.

2. The moving object detection device according to claim 1, wherein
for each of the one or more second regions, the estimation unit is configured to estimate, as the second motion vector, a representative vector representing the first motion vectors of the first regions included in the second region.

3. The moving object detection device according to claim 1, wherein
the first regions which are the unit regions are obtained by dividing the captured image into rows and columns, and
each of the one or more second regions includes a row or a column of first regions among the first regions.

4. The moving object detection device according to claim 1, wherein
the detection unit is configured to calculate, for each of the first regions, a third motion vector by subtracting, from the first motion vector of the first region, the second motion vector of the second region which includes the first region, and detect the moving object by determining whether the moving object is present in the first region, based on the third motion vector.

5. The moving object detection device according to claim 4, wherein
when a magnitude of the third motion vector is greater than a predetermined threshold and a direction of the third motion vector is toward an approximate center of the captured image, the detection unit is configured to determine that the moving object is present in the first region.

6. A moving object detection method comprising:
obtaining a captured image by capturing a view in a travel direction of a vehicle;
calculating, for each of first regions which are unit regions of the captured image, a first motion vector indicating movement of an image in the first region;
estimating, for each of one or more second regions which are unit regions each including the first regions, a second motion vector using first motion vectors of the first regions included in the second region, the second motion vector indicating movement of a stationary object which has occurred in the captured image due to the vehicle traveling; and
detecting a moving object present in the travel direction, based on a difference between one of the first motion vectors and one of the one or more second motion vectors.

7. An image processing device comprising:
a calculation unit configured to calculate, for each of first regions which are unit regions of a captured image obtained by an image capturing device capturing a view in a travel direction of a vehicle which is equipped with the image capturing device, a first motion vector indicating movement of an image in the first region;
an estimation unit configured to estimate, for each of one or more second regions which are unit regions each including the first regions, a second motion vector using first motion vectors of the first regions included in the second region, the second motion vector indicating movement of a stationary object which has occurred in the captured image due to the vehicle traveling; and
a detection unit configured to detect a moving object present in the travel direction, based on a difference between one of the first motion vectors and one of the one or more second motion vectors.

8. An integrated circuit comprising:
a calculation unit configured to calculate, for each of first regions which are unit regions of a captured image obtained by an image capturing device capturing a view in a travel direction of a vehicle which is equipped with the image capturing device, a first motion vector indicating movement of an image in the first region;
an estimation unit configured to estimate, for each of one or more second regions which are unit regions each including the first regions, a second motion vector using first motion vectors of the first regions included in the second region, the second motion vector indicating movement of a stationary object which has occurred in the captured image due to the vehicle traveling; and
a detection unit configured to detect a moving object present in the travel direction, based on a difference between one of the first motion vectors and one of the one or more second motion vectors.
